(19) United States
(12) Patent Application Publication
(10) Pub. No.: US 2019/0171437 A1
(43) Pub. Date: Jun. 6, 2019

(54) SERVER AND SYSTEM FOR VERSIONING FOR SOFTWARE IN THE CONTEXT OF MULTI-TENANCY

(71) Applicant: nPhase, Inc., Encinitas, CA (US)

(72) Inventors: Jaya Prakash R. Guda, Cupertino, CA (US); Iov Florin Gherman, Baia Mare (RO); Scott A. Climes, Encinitas, CA (US)

(21) Appl. No.: 16/209,852

(22) Filed: Dec. 4, 2018

Related U.S. Application Data
(60) Provisional application No. 62/594,373, filed on Dec. 4, 2017.

(51) Int. Cl. G06F 8/65; G06F 8/61; G06F 8/71

(52) U.S. Cl. CPC G06F 8/65; G06F 8/71; G06F 8/61

(57) ABSTRACT

A system and method for managing subscribed software application versions that includes determining application features in a subscribed software application version and determining the needed front-end components for the subscribed software application version and the requirements of an upgraded version. This method may allow a user to use multiple software versions for different specific requirements in a software-as-a-service environment. The system and method provides a software version management module in communication with a database. The database is in communication with an application version change module that assists in managing the components of the various software versions.

### RELATED APPLICATIONS

This application claims the benefit of and priority to U.S. Provisional Application No. 62/594,373, filed Dec. 4, 2017, the entire contents of which are incorporated by reference.

### BACKGROUND

### 1. Field

The present invention relates generally to the field of computer technologies. More particularly, embodiments of the present invention relate generally to maintaining multiple versions of Software as a Service (SaaS) applications (e.g., cloud-computing based software) in the context of multi-tenancy and application management systems.

### 2. Description of the Related Art

Software as a Service (SaaS) typically involves a software licensing and delivery model in which software is licensed on a subscription basis and is centrally hosted for access by the licensees. In many cases, business applications such as office software, messaging software, payroll processing software, database management system (DBMS) software, as well as healthcare software may be provided using SaaS delivery. Healthcare software may include software used to manage electronic health records and clinical trials.

This trend of providing SaaS instead of the classical on-premises installation has changed the way that software is managed. In the past, software releases occurred infrequently and a customer would choose when to switch to a new version. With SaaS, providers can release software updates continuously if desired and deploy the updates without further action by a customer or subscriber.

Software applications may be either single tenant software applications or may comprise multi-tenant architectures. As used herein, a “tenant” is one or a group of users, such as an organization, who share a common access with specific privileges to the software instance. A single tenant software application consists of an architectural setup in which a single customer has a copied instance of the software application. Each tenant has a versioned copy of the application's main code base and all customizations occur via data-driven configurations, Application Programming Interfaces (API), or programmatic intervention. All tenants are separately hosted on their own servers and the environments are not mixed.

In contrast, software vendors may alternatively utilize a multi-tenant architecture. Multi-tenancy refers to a software architecture in which a single instance of a software application serves multiple “tenants”. With this architecture, a software application may be designed to provide every tenant a dedicated share of the software instance, including its data, configuration, user management, tenant individual functionality and non-functional properties. Such a multi-tenant architecture may serve multiple businesses and users, with data partitioned accordingly. SaaS may be a preferred delivery method for certain ventures or applications because single-tenant applications may be too expensive, inefficient, or not scalable. As the software is improved, all tenants benefit in a multi-tenant architecture.

In a SaaS model, there may only be one version of the application used by all clients. The SaaS provider's resources are focused on maintaining a single, current version of the application instead of supporting multiple software versions for different users or customers. As a result, no customer is left behind when the software is updated with new features and innovations. In addition, the customer is free to spend time on new functionality that may drive improvements in productivity and innovation. Customers are also free from concerns about high-cost software upgrades.

While SaaS offers many advantages, some customers may be adversely affected by the continual updates to the software. This may be especially true for customers in clinical trials, healthcare, e-commerce, and/or banking, among other fields. Customers in such areas may not be able to use a single version of the software to meet all their needs. In clinical trials, continuous software upgrades may pose a particular challenge in light of certain regulations that must be followed. For example, under Title 21 CFR Part 11, a validated clinical trial configuration is invalidated with continuous software upgrades. Such regulations mandate User Acceptance Testing (UAT) whenever the SaaS provider upgrades the software used in the clinical trial. As a result, many clinical trials using SaaS applications are reluctant to adopt a new version for clinical trials already underway. In some cases, a later version may not provide sufficient value or improvements to a user to justify the time and expense needed to complete UAT. There may also be technical incompatibilities between interfaces, for example if a user uses an extension that depends on a specific application programmable interface (API) functionality that has been altered or removed. In this situation, the SaaS provider will have to maintain the outdated version for those customers unable or unwilling to switch to a newer version.

The inability of SaaS customers in regulated industries or fields to immediately switch to a new version of the software creates significant challenges to SaaS providers and the SaaS business model. It may be necessary for the SaaS provider to keep the outdated version of the software for those customers, essentially providing a single-tenant version just for those customers. This requirement may persist for a considerable time, as many clinical trials may last five to seven years or more.

Another challenge for SaaS providers involves customers who may be required to use older or outdated versions of the software for existing uses, but want to use newer versions of the software for newer requirements, such as new clinical trials. For example, one of the studies in a clinical trial may be on an older or outdated version of the software while newer studies may be on a newer version of the software. Accordingly, SaaS providers face major challenges to serve different versions of their software to multiple tenants at the same time, while preserving the SaaS business model.

Thus, there is a need in the art for a software management method which solves the problem of providing different versions of software to multiple tenants at the same time that minimizes the need for additional investment in infrastructure, and is efficient and scalable.

### SUMMARY OF THE INVENTION

Some embodiments include a computer-implemented method comprising an Internet enabled or coupled a web server, and providing an Internet enabled or coupled domain authority server. Some embodiments include providing an Internet enabled or coupled application server, where the application server is configured to be coupled to a centralized database and at least one respondent display, at least one of the web servers, and the domain authority server. Some further embodiments include providing a non-transitory computer-readable medium coupled to at least one computing device and having instructions stored thereon which, when executed by the at least one computing device, cause the at least one computing device to perform one or more operations of a method of managing software application versions.

In some embodiments, the operations of the method include determining application features in a version of a software application. In some further embodiments, the operations include determining front-end components for the software application. In some further embodiments, the operations include determining subscription requirements for subscribing to an upgraded version of the software application.

In some further embodiments, the operations include installing the upgraded version of the software application. In some embodiments, the operations include providing a user with access and use-rights to the software application by automatically validating the upgraded version of the software application.

In some embodiments, the automatic validating includes a validation of meeting specific requirements of one or more specific regulations. In some embodiments, the specific regulations are based on a validated clinical trial configuration. In some further embodiments, the specific regulations are based on a regulation of Title 21 CFR Part 11.

In some embodiments of the invention, the upgraded version is a later or newer version of the software application version. In some embodiments, the application server configures a user display of one or more listings of multiple software application versions. In some embodiments, the application server and/or the domain server enables a user to subscribe to multiple versions of the software application version. In some further embodiments, the application server and/or the domain server enables a user to update at least one software application version.

In some embodiments, installing the upgraded version of the software application comprises replacing one or more corresponding software components of a previously installed software application.

Some embodiments further comprise comparing application features of a software application version with an upgraded software application version to determine software components required by the upgraded software application version.

In some embodiments, the upgraded software application version upgrade incorporates at least one incremental software component package. In some further embodiments, the upgraded software application version upgrade is automatically validated against predetermined criteria for regulatory compliance and integrity.

Some embodiments include a system comprising an Internet enabled or coupled web server, and a software version management module. Some embodiments include a database in communication with the software version management module. In some embodiments, the system includes an application version change module in communication with the software version management module and a database. Some embodiments include an application validation module in communication with the software version management module and the database. Some embodiments include a non-transitory computer-readable medium coupled to at least one computing device and having instructions stored thereon which, when executed by the at least one computing device, cause the at least one computing device to perform operations of a software version management system.

In some embodiments, the system includes operations of determining application features in a version of a software application. In some embodiments, the system includes operations of determining front-end components for the software application.

In some embodiments, the system includes operations of determining subscription requirements for subscribing to an upgraded version of the software application. In some embodiments, the system includes operations of installing the upgraded version of the software application.

In some embodiments of the system, operations can include providing a user with access and use-rights to the software application by automatically validating the upgraded version of the software application.

In some embodiments of the system, the software application originates from or is authorized by at least one of an Internet enabled or coupled domain authority server and an Internet enabled or coupled application server coupled to the database.

In some embodiments of the system, the database of the system is configured to provide multiple software version components for a software upgrade in response to a query from the software version management module. In some embodiments, the system includes automatic validating that includes a validation of meeting specific requirements of one or more specific regulations of Title 21 CFR Part 11.

In some embodiments of the system, operations of a software version management system can comprise configuring a user display of one or more listings of multiple software application versions. In some embodiments, an upgraded software application version upgrade is automatically validated against predetermined criteria for regulatory compliance and integrity.

In some embodiments of the system, software application is a user-subscribed software application.

### BRIEF DESCRIPTION OF THE DRAWINGS

Other systems, methods, features, and advantages of the present invention will be or will become apparent to one with skill in the art upon examination of the following figures and detailed description. It is intended that all such additional systems, methods, features, and advantages be included within this description, be within the scope of the present invention, and be protected by the accompanying claims. Component parts shown in the drawings are not necessarily to scale and may be exaggerated to better illustrate the important features of the present invention. In the drawings, like reference numerals designate like parts throughout the different views, wherein:

FIG. 1 is a system block diagram of a computer system according to an embodiment of the present invention;

FIG. 2 is a block diagram of a structure of a software management system providing access to a release of a software application according to an embodiment of the present invention;

FIG. 3 is a flow chart of a method of setting up software to provide access to a release of a software application according to an embodiment of the present invention;

FIG. 4 illustrates a screen summary of the user's screen with details about the software version and features, according to an embodiment of the present invention;

FIG. 5 illustrates a screen illustrating software application version selection according to an embodiment of the present invention;

FIG. 6 is a flow chart of a method of performing a software upgrade according to a further embodiment of the present invention;

FIG. 7 illustrates a screen summary of the user's screen with options for changing version and changing status, according to a further embodiment of the invention;

FIG. 8 is a block diagram of a structure of a software management system providing upgrades to a subscribed software application in according to a further embodiment of the invention;

FIG. 9 illustrates a screen summary of a user initiating a change to a software version, according to a further embodiment of the invention;

FIG. 10 illustrates a screen view showing a change to a software version according to a further embodiment of the invention; and

FIG. 11 illustrates a screen view showing multiple software version subscriptions, according to embodiments of the invention.

FIG. 12 illustrates a computer server system configured for operating and processing components of the system in accordance with some embodiments of the invention.

### DETAILED DESCRIPTION

The detailed description of exemplary embodiments herein makes reference to the accompanying drawings and pictures, which show the exemplary embodiments by way of illustration and its best mode. While these exemplary embodiments are described in sufficient detail to enable those skilled in the art to practice the invention, it should be understood that other embodiments may be realized and that logical and mechanical changes may be made without departing from the spirit and scope of the invention. Thus, the detailed description herein is presented for purposes of illustration only and not of limitation. For example, the steps recited in any of the method or process descriptions may be executed in any order and are not limited to the order presented. Moreover, any of the functions or steps may be outsourced to or performed by one or more third parties. Furthermore, any reference to singular includes plural embodiments, and any reference to more than one component may include a singular embodiment.

Some embodiments of the invention include a method of managing multiple versions of a software application. In some embodiments, the method includes determining features in a given version; determining front-end components (which may include: forms, menu items, messages, user interface components, controls, widgets, cascading style sheet (CSS) elements, among others); determining server-side components (which may include classes, libraries, business logic, application interfaces, among others); determining database components (which may include tables, columns, views, triggers, database procedures, functions, sequences and the like); determining the requirements to subscribe to a release of the application; determining changes needed for an upgrade of an existing version of the subscribed application to a newer version; and in response to an upgrade request from the software client: upgrading an existing application; and receiving an application upgrade confirmation message from the software client and/or server.

Some embodiments include a computer system for subscribing to a release of the software application on the server or upgrading an application previously subscribed to may comprise: one or more processors, memory, and one or more programs stored in the memory to be executed by the processors. The one or more programs further include instructions for subscribing to a release of the application; determining the changes needed for an upgrade of an existing version of the subscribed application to a newer version; and in response to an upgrade request from the software client: upgrading an existing application; and receiving an application upgrade confirmation message from the software client and/or server.

Some further embodiments of the invention include a non-transitory computer-readable medium storing one or more programs, the one or more programs comprising instructions, which when executed by a server, cause the server to: determine the application features, front-end components (which may include forms, menu items, messages, user interface components, controls, widgets, CSS elements, and similar components); database components (which may include: tables, columns, views, triggers, database procedures, functions, sequences, and similar components); determining the requirements for subscribing to a release of the application; determining the changes needed for an upgrade of an existing version of the subscribed application to a newer version of the subscribed application; and in response to an upgrade request from the software client: upgrading an existing application; and receiving an application upgrade confirmation message from the software client and/or server.

Embodiments disclosed herein provide methods of managing multiple versions of software applications. More specifically, embodiments of the disclosure provide a software version model (“SVM”) that includes: application features, front-end components, server-side components, database components, and an application version management module (“AVM”). The front-end components may include but are not limited to: forms, menu items, messages, user interface components, controls, widgets, and CSS elements, and/or may include other elements that control or affect the appearance of the software on a user's screen. The server-side components may include: classes, libraries, business logic, and application interfaces, and may include other elements related to the type of data managed, manipulated, or presented by the software version model. Database components may include but are not limited to: tables, columns, views, triggers, database procedures, function and sequences.

An application version management module may be maintained at the server and provides a choice of the available versions of the software for the customer, user, and/or client to select. The application version management module uses programming logic to identify the application features and supporting components needed, for example, by querying the software version model. Once the application version management module has determined the application features and supporting components required it may then run a setup process to provide access to the selected version or release of the application. The SVM, AVM, and/or any of their associated elements or components may be different in an alternative embodiment. In an alternative embodiment, any of a variety of software functional blocks and/or hardware may be used to implement a desired system for allowing user selection of software version, as exemplary discussed in greater detail herein.

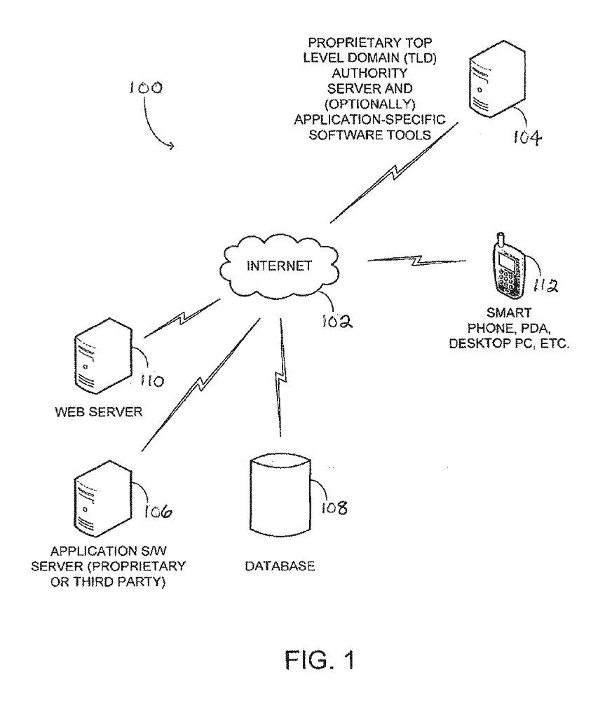

FIG. 1 is a system 100 block diagram illustrating the system used in conjunction with the method of versioning for software in the context of a multi-tenancy described herein. The system 100 may be one embodiment of incorporating an environment for allowing selection of software versioning by a customer, user, and/or client. In some embodiments, the system 100 includes an Internet 102 connected with a top-level domain server 104. In one embodiment, the top-level domain server 104 may provide selective access to one or more application-specific software tools, for example, one or more of multiple versions of software tools, software systems, subcomponents, or software functions. Alternatively, or additionally connected to Internet 102 may be another application software server 106, which may be proprietary or third party. In some embodiments, a database 108 (or other memory configuration) may also be connected to Internet 102 to provide software users with database management support or other stored data configuration. In some embodiments, one or more traditional web servers 110 may also be connected to Internet 102 to provide traditional browser access by users. In an alternative embodiment, non-traditional or specialized web servers and/or browser access may be used. In some embodiments, one or more user devices 112, such as desktop computers, laptop computers, tablets, smartphones, or other user Internet-enabled or network devices may also be connected to the Internet 102 so that user has access to the application software residing on any or all of the top-level domain server 104, and/or the application software server 106, and/or the web server 110. In some embodiments, the server on which the SaaS software resides or is operatively coupled with may execute the software instructions when requested by a user. In an alternative embodiment, greater components, fewer components, and/or alternative components may be used other than those specifically illustrated in the embodiment shown by FIG. 1.

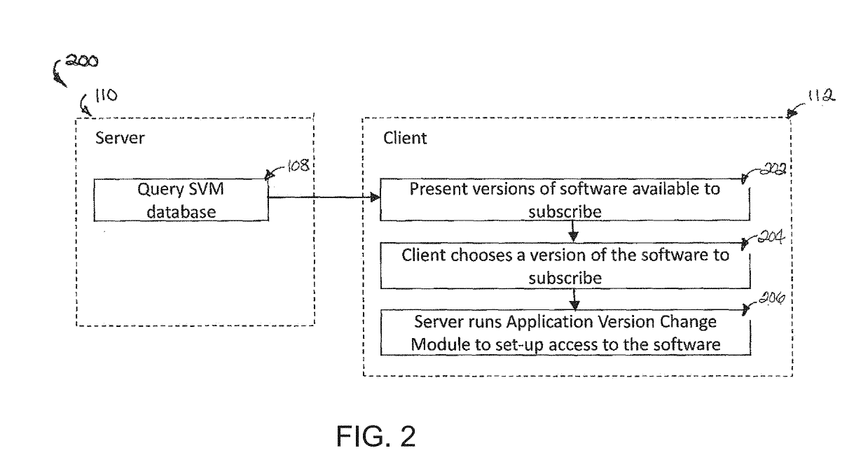

FIG. 2 is a block diagram of a software management system 200 providing access to a release of a software application according to at least one embodiment of the invention. In some embodiments, certain features, functionality, or interactions of the software management system 200 may be the same as or similar to previous versions. With reference to certain aspects of FIG. 1, the software management system 200 may be hosted by the traditional web server 110, and/or may be hosted by the application software server 106. In some embodiments, web server 110 is in communication with or otherwise accessible by client 112. In some embodiments, in operation, software management system 200, in a first step 202, may present versions of software to a user that are available for subscription and/or access or use.

In some embodiments, the user, in a second step 204, may select a version of the software and subscribe or access such version. In some embodiments, in a third step 206, the web server 110 can run an application version change module (or other hardware configured to execute corresponding instructions) in order to set up access to the selected software or software subscription. As discussed in greater detail herein, such access may allow a user to choose a specific version for the user's software or at least part of the user's software. Accordingly, in some embodiments, one user may be allowed to use a first version of the software (or at least some part of the first version of the software) while another user may be allowed to use a second version of the software (or at least some part of the second version of the software). In some embodiments, at least some portion of the first version of the software can be can be different from at least some portion of a second version of the software.

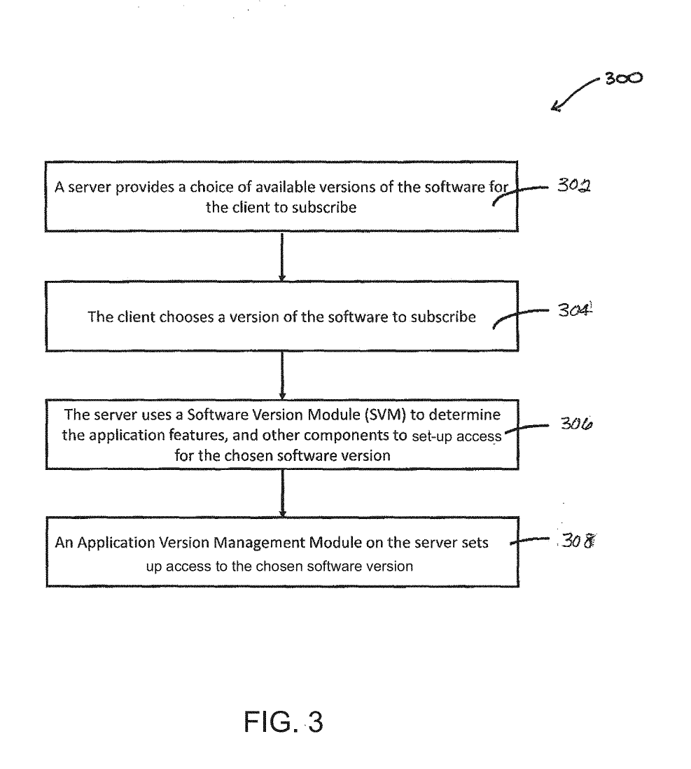

FIG. 3 is a flow chart of a method 300 of setting up software to provide access to a release of the software application (or part of a software application, such as a particular software function or other feature), in accordance with an embodiment disclosed herein. In some embodiments, the method 300 can include a step 302 with a server providing one or more available versions of the software for customer subscriptions. In some embodiments, the server can use a database query to obtain the new application features and/or components with respect to the software setup. In some embodiments, the server can then present or otherwise make available one or more versions of the software to the user and/or information associated with the versions, such as particular features that may be available and/or have changed between software versions. In some embodiments, the versions or other related information may be provided by a list or a screen view (e.g., on a graphical user interface) that highlights the details specific to each version of the software. For example, some embodiments include information to better inform subscribers about the features and options available in each version.

In some embodiments, programming logic or computer instructions may be used by querying a software version model (SVM), or other component or set of components or instructions, to obtain or determine the application features and/or components with respect to the selected software subscription. Such programming logic or instructions, for example, associated with the server 110, may provide the various software applications versions, and can aid in providing savings in infrastructure costs and reducing the cost of the SaaS model.

In some embodiments, in step 304, the customer can select a software version subscription or other selection indicative of a software version or feature or set of features desired. In some embodiments, the customer may make their subscription selection using an Internet-based application in one embodiment. In some embodiments, in step 306, once the customer has selected a software version, the server 110 may use a SVM to determine the software application version features and other components that may be needed to set up access to the selected software version subscription. In some embodiments, the server 110 may use a database query to obtain the features and components applicable to the selected software version. In some embodiments, in step 308, an application version management module (AVM) or other component or set of components or instructions on server 110 can install, provide access to, and/or upgrade the software selected for subscription. In some embodiments, this step may activate the corresponding software components of the software subscription on the server 110.

In one non-limiting example embodiment, if one version of a software (e.g., such as a software version 1.1) uses one or more different software components than one or more software components used by or in another software version (e.g., software version 1.0), such as a software function, module, executable, etc., the user who selects version 1.1 can be given access to the one or more different software components associated with software version 1.1. In some embodiments, other users using software version 1.0 who opt not to use or upgrade to software version 1.1, may continue having access to and using the one or more different software components associated with software version 1.0. In certain embodiments, additional steps may be taken prior to or after access to the chosen software version is provided. For example, if a user selects an updated version and/or set of one or more features for the software, additional compensation or payment from the user may be required before the user has access those features and/or the user may be billed after access is provided.

A non-limiting example of access to software subscription flow can be shown by taking the setup of a clinical trial study as an example. For example, a customer may be presented with various versions of software, such as cloud software (e.g., Cloud 1.0, Cloud 1.1, Cloud 1.2, etc.) The customer can select the software version for a clinical study for subscription, Cloud 1.0, and the server can use the SVM to obtain the application features and components, and the AVM on server 110 can activate the software with the corresponding application versions and features. This embodiment only requires a user to select the version of the software for subscription and server 110 manages the setup and access process, allowing multiple versions of the software to coexist for multiple tenants at the same time, thus providing savings in infrastructure costs.

Some embodiments include automatic validating of a version of a software or portion of the software. For example, some embodiments include automatic validating of a version of a software or portion of the software that includes a validation of meeting specific requirements of one or more specific regulations. In some embodiments, the specific regulations can be based on a validated clinical trial configuration. In some further embodiments, the specific regulations are based on a regulation of Title 21 CFR Part 11.

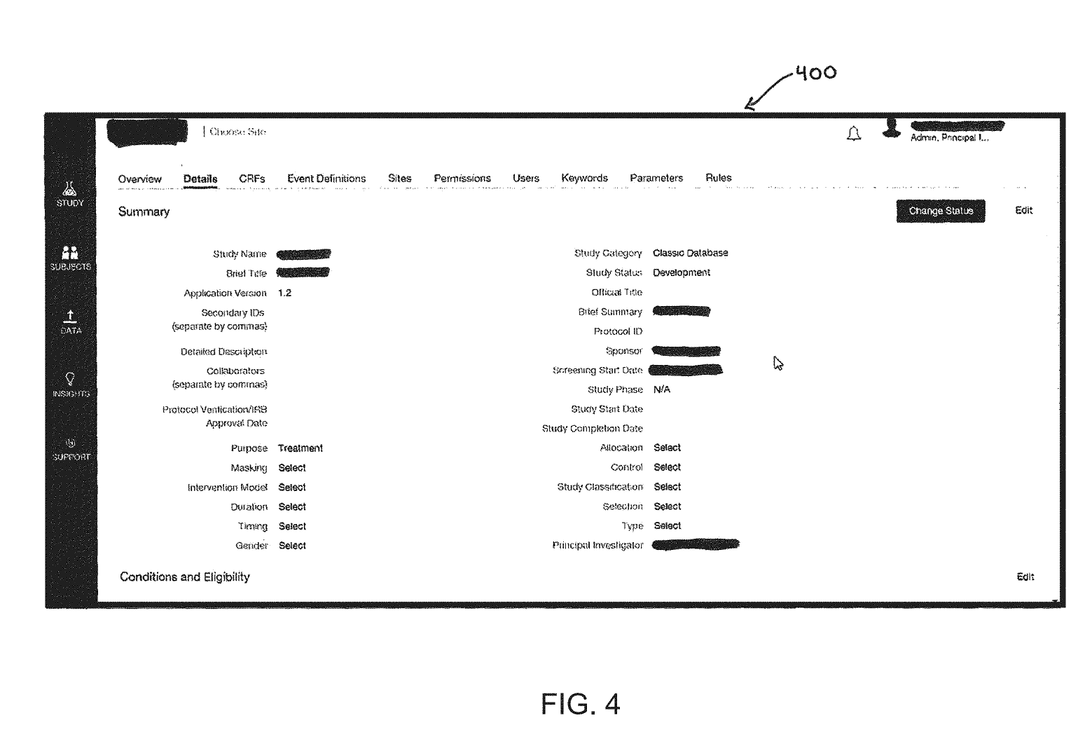

In some embodiments, the server can present or otherwise make available information related to one or more versions of software by a list or a screen view (e.g., on a graphical user interface). For example, FIG. 4 provides a screenshot of a summary screen 400 that a user may see when making a software version and/or subscription selection. In some embodiments, the summary screen 400 may be included as part of a software system or coupled to a conventional software system. In some embodiments, specifically illustrated, the application version for the software can be displayed and various selectable features are shown.

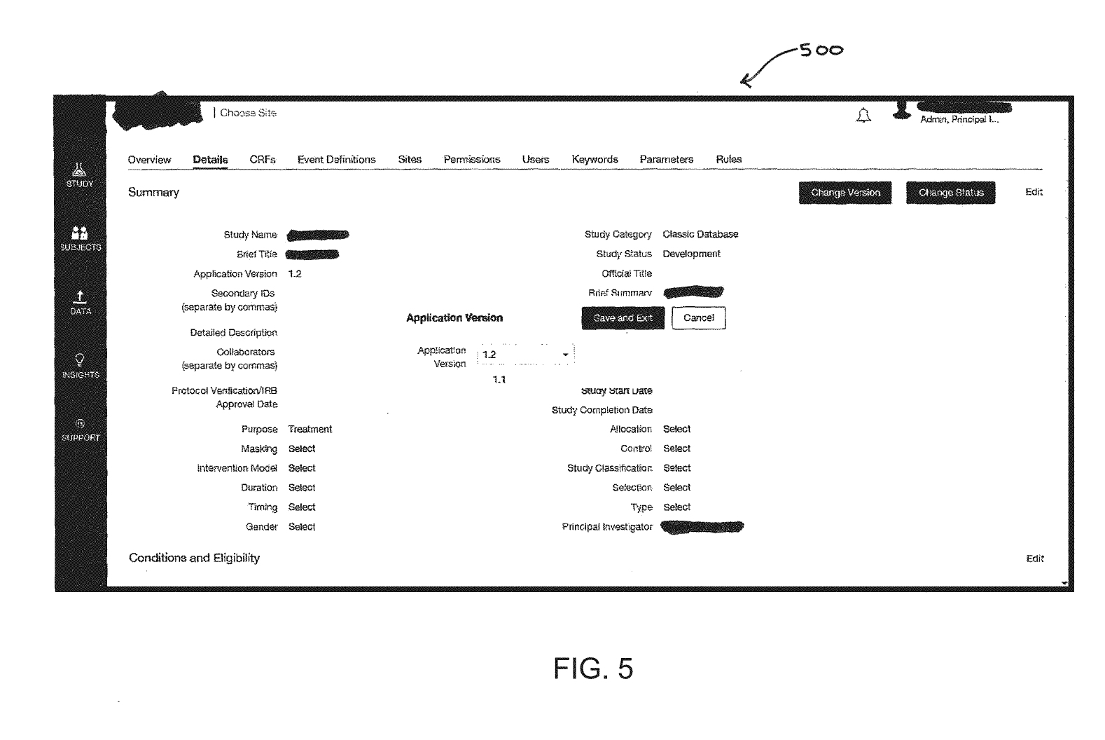

FIG. 5 provides a screenshot of an application version selection screen 500 in accordance with some embodiments of the invention. In some embodiments, the application version selection screen 500 may be included as part of a software system or coupled to a conventional software system. For example, as specifically illustrated, in some embodiments, the user can be shown a set of selections for various software versions with selection options, buttons, and/or other user interface elements to make the selection. In some embodiments, these screen options can be presented in various other forms without departing from the spirit and scope of the invention.

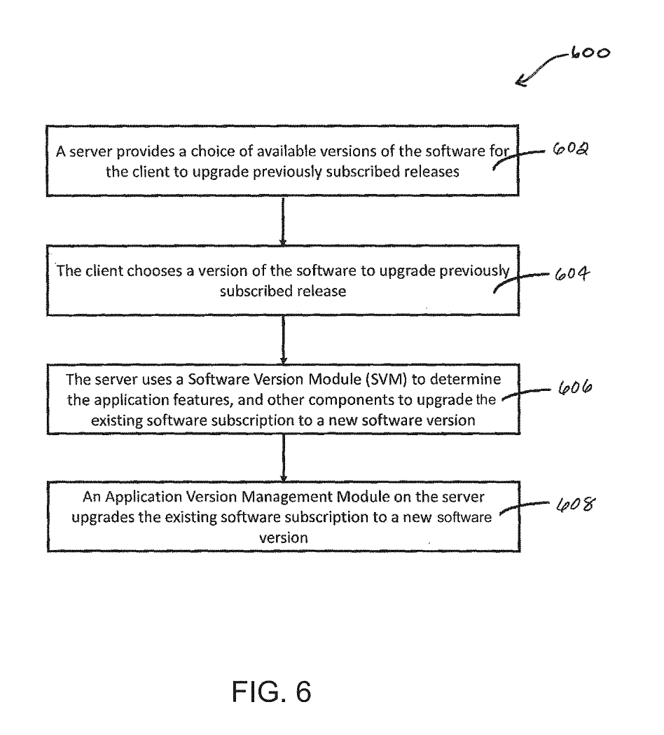

FIG. 6 is a flow chart of a method 600 for upgrading software and/or changing to a different software version, in accordance with an additional embodiment. With reference to elements of FIG. 1, the method 600 begins with step 602 where a server (such as the server 110) provides a choice of versions of the software for the customer to select from when deciding to update or upgrade the software application. In this embodiment, an old or outdated software version refers to an old or outdated version package that was previously released or accessible by or for a software application, while a software upgrade package may refer to a completely new version package of the software application. In some embodiments, a software incremental package is a file generated using programming logic or computer instructions to identify the software application features and supporting components needed to compare differences between the old or outdated software version previously released, and the software upgrade packaged. In some embodiments, this incremental package file may be obtained, for example, by querying the SVM. The results of the query may be presented to the customer for selection.

In this embodiment, programming logic or computer instructions may be used in the query by the SVM to compare the application features of the old or outdated software package and the software upgrade package to obtain the new application features and components with respect to the software upgrade package. In some embodiments of the invention, the server 110 and/or similar servers may store the details of the software incremental package, so that the customer can choose the version of the software to upgrade. In some embodiments, to enable upgrade or change of customer's software and/or software subscriptions in various versions, where the customer needing an upgrade merely selects the version of the software, the server 110 may query and/or determine multiple software incremental packages with respect to software upgrade packages in other versions of the software packages. In some embodiments, this version selection may allow a customer to upgrade or change to any version of the software. As a result, in some embodiments, a customer's software and/or software subscription upgrade is not limited to a particular version of the software. In some embodiments, the server 110 can contain logic to provide the various software application versions, thus saving infrastructure costs and lowering SaaS model costs.

In some embodiments, in step 604, the customer can select a version of the software to upgrade a previously subscribed release. In some embodiments, this version selection may be performed using an Internet 102 based application. In some embodiments, in step 606, the server 110, for example by using a SVM, can determine the one or more software application features and/or other components needed to upgrade the subscription to the newly-selected version. In this embodiment, server 110 may use a database, or other memory query, to compare the application features of the old or outdated software application version package and the new software version application package, and/or to obtain the new software version application features and/or components of the new software upgrade package. In some embodiments, in step 608, the AVM on server 110 can upgrade or change the customer's software version and/or subscribed software version. For example, in some embodiments, the server 110 may run a program or set of instructions that replaces the corresponding software components of the old or outdated software version with the components needed to upgrade the customer's software and/or subscribed software to include the desired application features and/or components of the new software version application package. In another example, the server 110 may run a program or set of instructions that provides access to one or more different software executables, functions, modules, instructions, etc. corresponding to the newly selected software version.

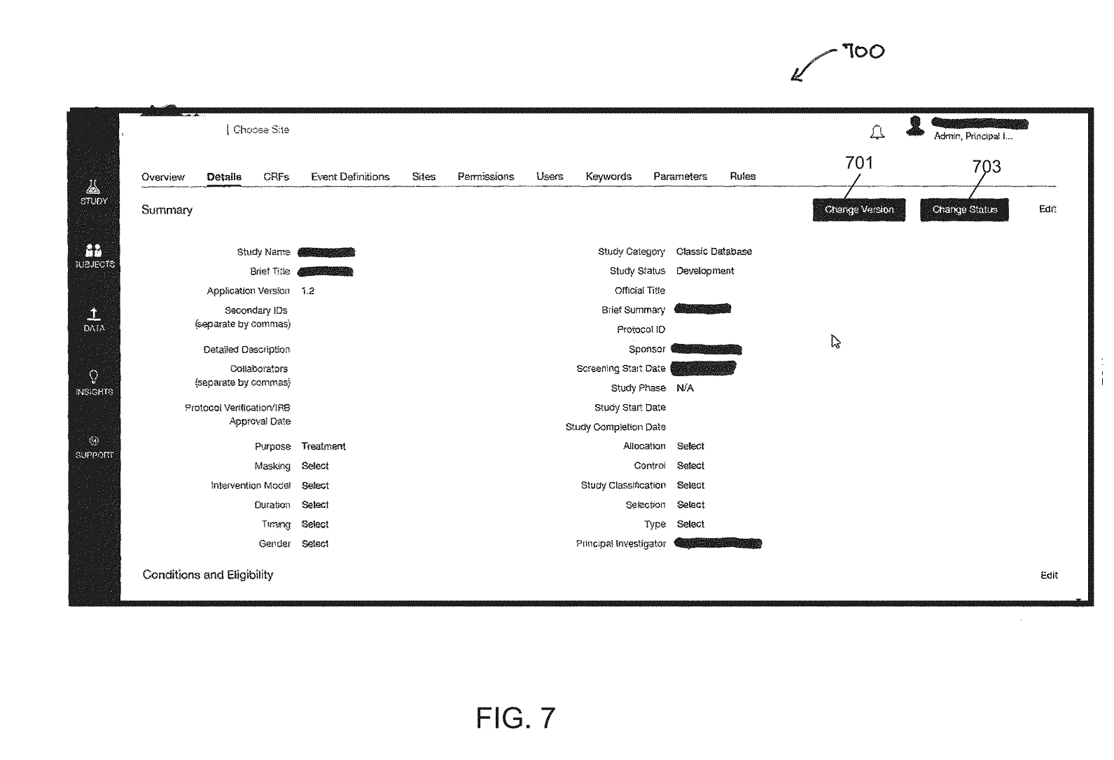

FIG. 7 shows a sample screen view 700 that a user may see when selecting to upgrade an application software package. In some embodiments, the screen view 700 may be included as part of a software system having features that are the same as or similar to those described earlier. For example, in some embodiments, the user may have the option to change versions by selecting the “Change Version” button 701 in the upper right and may also view “Change Status” 703 by selecting that button.

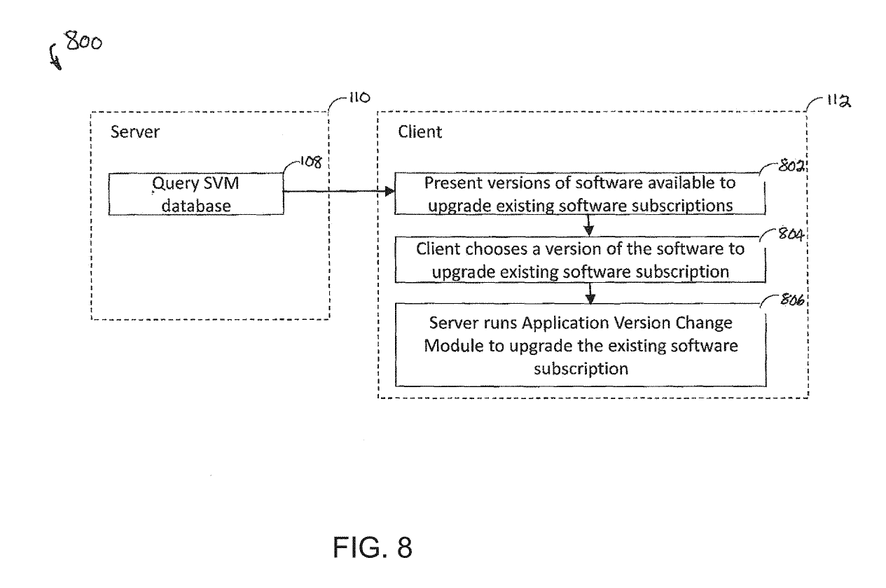

FIG. 8 is a block diagram of a software management upgrade system 800 for providing access to an upgrade of a software application according to at least one embodiment of the invention. In some embodiments, the software management upgrade system 800 may include features, functionality, and/or interactions that are the same as or similar to those previously disclosed. For example, with respect to the various elements of FIG. 1, in some embodiments, the software management upgrade system 800 may be hosted by the web server 110, and/or may be hosted by an application software server 106. As previously shown, in some embodiments, the web server 110 may be in communication with client 112. In operation, in some embodiments, the software management upgrade system 800, in a first step 802, may present one or more versions (and/or features associated with such versions) of software to a user that are available for upgrading or changing an existing software application. In some embodiments, the client 112, in a second step 804, may select a version of the software for upgrade. In a third step 806, the web server 110 can run an application version change module, or other component or set of components or instructions, to set up access to the selected software subscription.

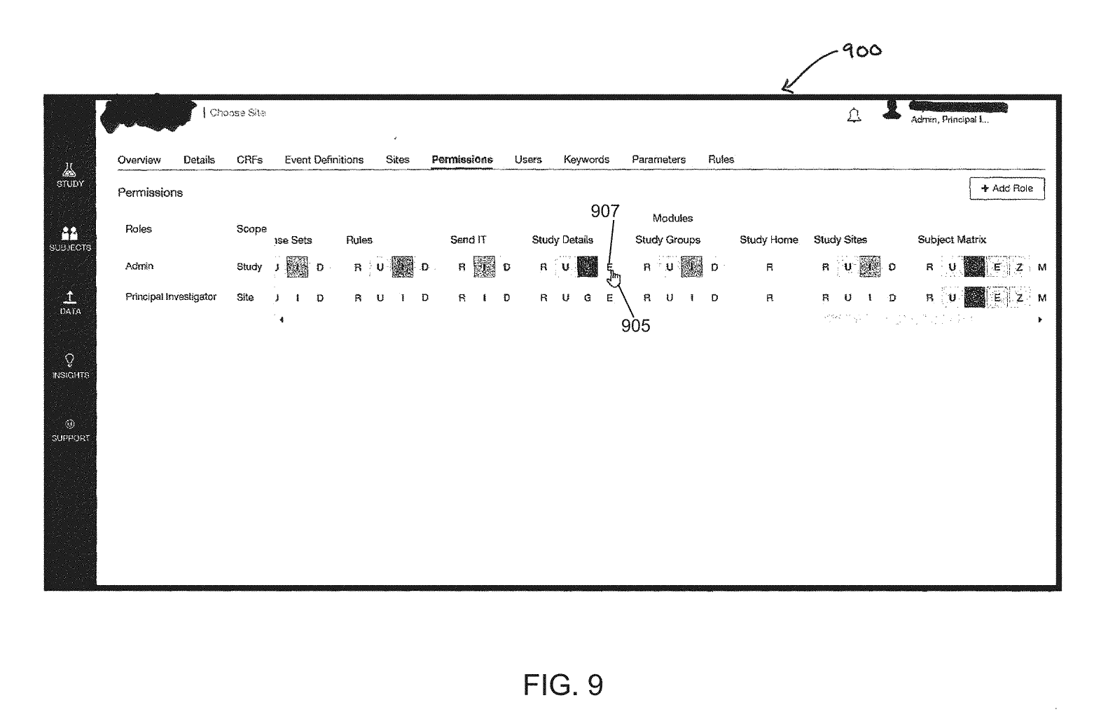

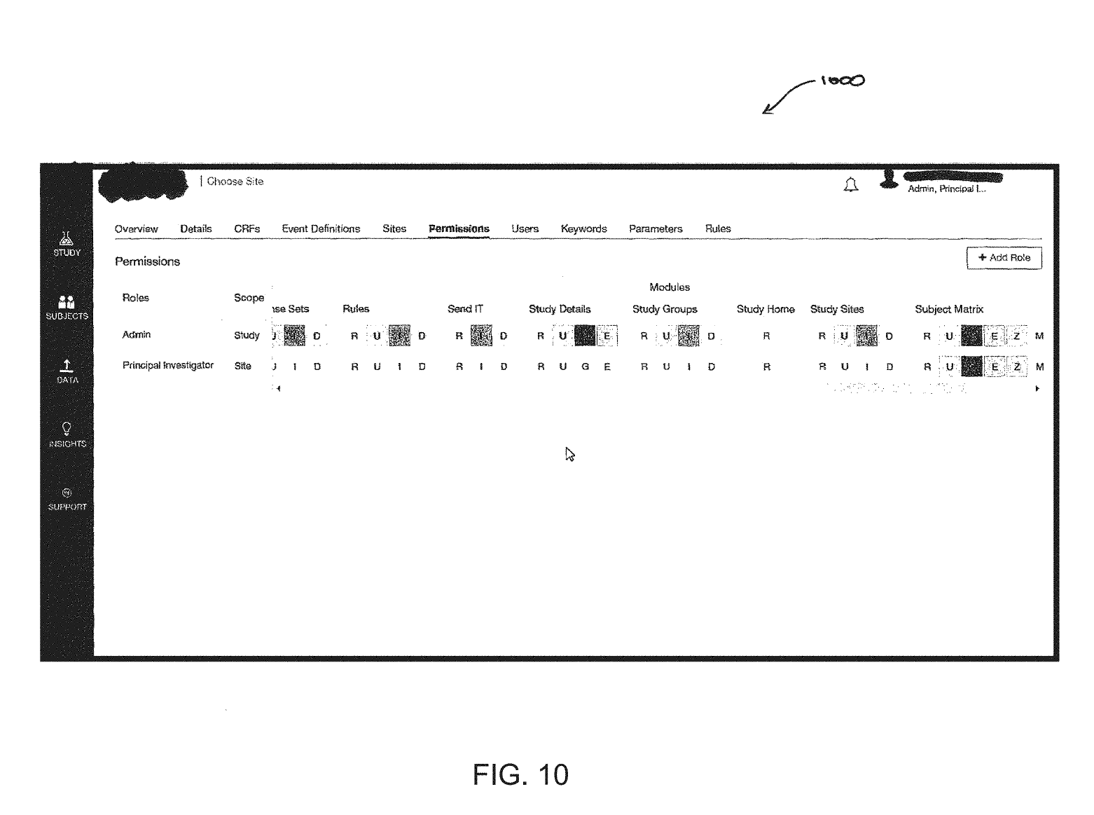

FIG. 9 shows a screen view 900 of a user making a change to a software version as described herein. In some embodiments, the screen view 900 may be included as part of a software system having features that are the same as or similar to those previously disclosed. For example, as specifically illustrated, in some embodiments, the user is making the change as an administrator. In the screen view depicted, the user has placed the mouse cursor 905, or other pointing device, to enable the permission required for a study selected to undergo a version upgrade. The present permission “E” of a particular study (marked as 907) can be shown as a particular visual indication (e.g., color). FIG. 10 shows the same screen view 1000 after the permission has been changed. In some embodiments, the screen view 1000 may be included as part of a software system having features that are the same as or similar to those previously disclosed. For example, as specifically illustrated, permission “E” can now appears as having a different visual indication (e.g., color) and/or can comprise another graphical or textural marking. For example, it is contemplated that other means besides color may be used to indicate versions of the software in use. In some embodiments, symbols, font styles, capitalization, or other similar distinguishing methods may be selected.

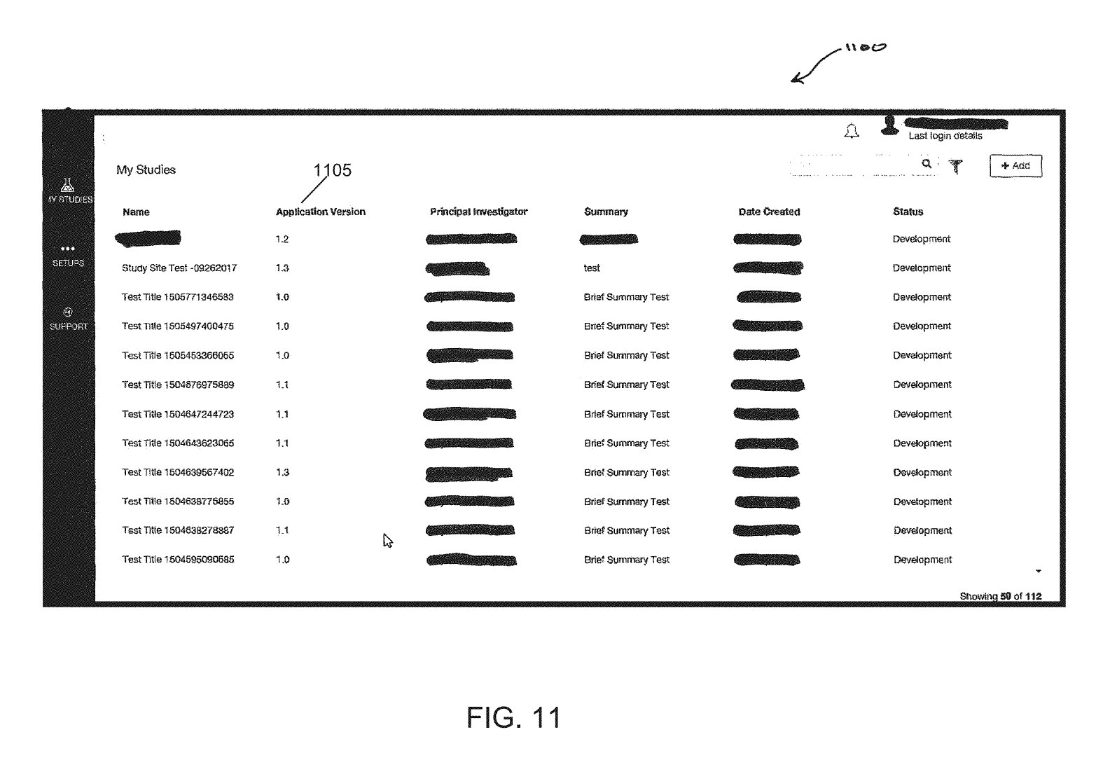

FIG. 11 shows a screen view 1100 of the various software versions in use by multiple studies and how different users of studies may use different versions of the software. The screen view 1100 may be included as part of a software system having features that are the same as or similar to those previously described. For example, as specifically illustrated, a user or administrator for one or more studies may view, using the screen view 1100, a list of the one or more studies that includes each of the versions (1105) corresponding to the one or more studies. As indicated and as discussed, a different version of the software may be in use for different studies being administered by the user or administrator.

Although the above embodiments illustrate and/or disclose particular software applications, environments, systems, and/or methods that have particular features or sets of features and particular components and/or sets of components, in an alternative embodiment, any of a variety of possible components, sets of components, software instructions, logic, software environments, and/or methods may be used to provide versioning capabilities in a multi-tenancy environment. Additionally, in some embodiments, fewer, and/or alternative method steps or components may be used to provide the desired versioning functionality in alternative configurations without departing from the disclosures and/or teachings of the invention.

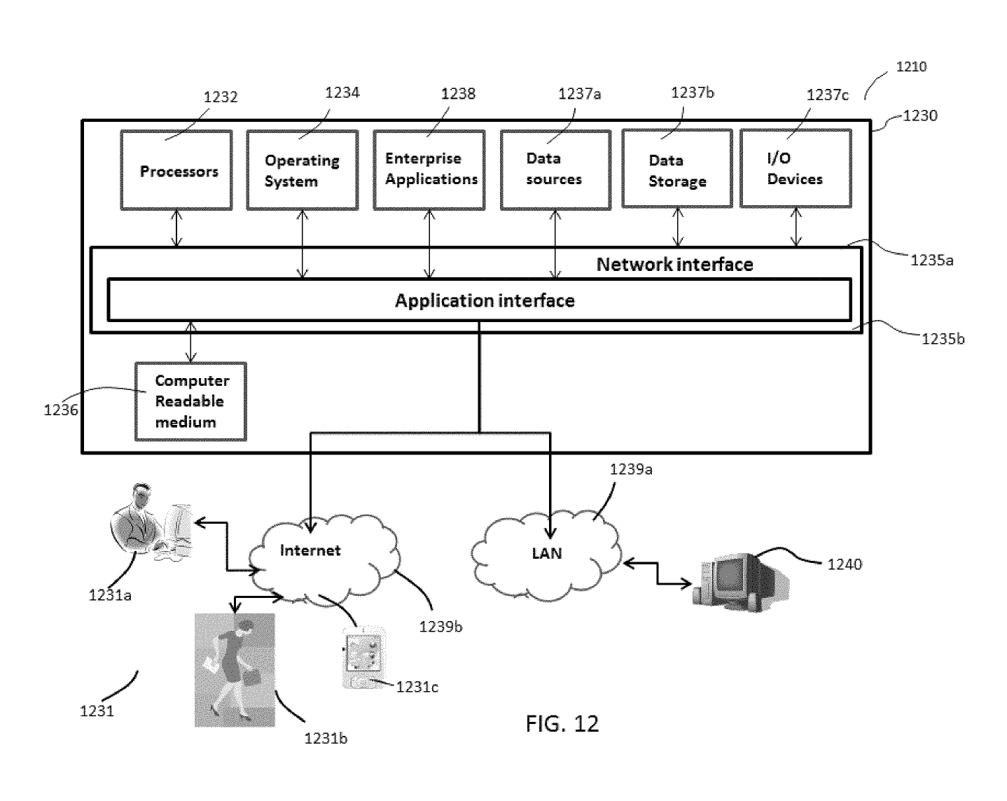

FIG. 12 illustrates a computer server system 1210 configured for operating and processing components of any of the systems or portions of the systems described earlier and illustrated in FIGS. 1-11. In some embodiments, the computer system 1210 can operate and/or process computer-executable code of one or more software modules of the system described earlier. Further, in some embodiments, the computer system 1210 can operate and/or display information related to one or more graphical user interfaces. In some embodiments, the system 1210 can comprise at least one computing device including at least one processor 1232. In some embodiments, the at least one processor 1232 can include a processor residing in, or coupled to, one or more server platforms. In some embodiments, the system 1210 can include a network interface 1250a and an application interface 1250b coupled to the least one processor 1232 capable of processing at least one operating system 1240. Further, in some embodiments, the interfaces 1250a, 1250b coupled to at least one processor 1232 can be configured to process one or more of the software modules (e.g., such as enterprise applications 1238). In some embodiments, the software modules 1238 can include server-based software modules. In some embodiments, the software modules 1238 can operate to host at least one user account and/or at least one client account, and operating to transfer data between one or more of these accounts using the at least one processor 1232.

With the above embodiments in mind, it should be understood that the invention can employ various computer-implemented operations involving data stored in computer systems. Moreover, the above-described databases and models throughout the system can store analytical models and other data on computer-readable storage media within the system 1210 and on computer-readable storage media coupled to the system 1210. In addition, the above-described applications of the system can be stored on computer-readable storage media within the system 1210 and on computer-readable storage media coupled to the system 1210. These operations are those requiring physical manipulation of physical quantities. Usually, though not necessarily, these quantities take the form of electrical, electromagnetic, or magnetic signals, optical or magneto-optical form capable of being stored, transferred, combined, compared and otherwise manipulated. In some embodiments of the invention, the system 1210 can comprise at least one computer readable medium 1236 coupled to at least one data source 1237a, and/or at least one data storage device 1237b, and/or at least one input/output device 1237c. In some embodiments, the invention can be embodied as computer readable code on a computer readable medium 1236. In some embodiments, the computer readable medium 1236 can be any data storage device that can store data, which can thereafter be read by a computer system (such as the system 1210). In some embodiments, the computer readable medium 1236 can be any physical or material medium that can be used to tangibly store the desired information or data or instructions and which can be accessed by a computer or processor 1232. In some embodiments, the computer readable medium 1236 can include hard drives, network attached storage (NAS), read-only memory, random-access memory, FLASH based memory, CD-ROMs, CD-Rs, CD-RWs, DVDs, magnetic tapes, other optical and non-optical data storage devices. In some embodiments, various other forms of computer-readable media 1236 can transmit or carry instructions to a computer 1240 and/or at least one user 1231, including a router, private or public network, or other transmission device or channel, both wired and wireless. In some embodiments, the software modules 1238 can be configured to send and receive data from a database (e.g., from a computer readable medium 1236 including data sources 1237a and data storage 1237b that can comprise a database), and data can be received by the software modules 1238 from at least one other source. In some embodiments, at least one of the software modules 1238 can be configured within the system to output data to at least one user 1231 via at least one graphical user interface rendered on at least one digital display.

In some embodiments of the invention, the computer readable medium 1236 can be distributed over a conventional computer network via the network interface 1250a where the system embodied by the computer readable code can be stored and executed in a distributed fashion. For example, in some embodiments, one or more components of the system 1210 can be coupled to send and/or receive data through a local area network (“LAN”) 1239a and/or an internet coupled network 1239b (e.g., such as a wireless internet). In some further embodiments, the networks 1239a, 1239b can include wide area networks (“WAN”), direct connections (e.g., through a universal serial bus port), or other forms of computer-readable media 1236, or any combination thereof.

In some embodiments, components of the networks 1239a, 1239b can include any number of user devices such as personal computers including for example desktop computers, and/or laptop computers, or any fixed, generally non-mobile internet appliances coupled through the LAN 1239a. For example, some embodiments include personal computers 1240a coupled through the LAN 1239a that can be configured for any type of user including an administrator. Other embodiments can include personal computers coupled through network 1239b. In some further embodiments, one or more components of the system 1210 can be coupled to send or receive data through an internet network (e.g., such as network 1239b). For example, some embodiments include at least one user 1231 coupled wirelessly and accessing one or more software modules of the system including at least one enterprise application 1238 via an input and output (“I/O”) device 1237c. In some other embodiments, the system 1210 can enable at least one user 1231 to be coupled to access enterprise applications 1238 via an I/O device 1237c through LAN 1239a. In some embodiments, the user 1231 can comprise a user 1231a coupled to the system 1210 using a desktop computer, and/or laptop computers, or any fixed, generally non-mobile internet appliances coupled through the internet 1239b. In some further embodiments, the user 1231 can comprise a mobile user 1231b coupled to the system 1210. In some embodiments, the user 1231b can use any mobile computing device 1231c to wireless coupled to the system 1210, including, but not limited to, personal digital assistants, and/or cellular phones, mobile phones, or smart phones, and/or pagers, and/or digital tablets, and/or fixed or mobile internet appliances.

In some embodiments of the invention, the system 1210 can enable one or more users 1231 coupled to receive, analyze, input, modify, create and send data to and from the system 1210, including to and from one or more enterprise applications 1238 running on the system 1210. In some embodiments, at least one software application 1238 running on one or more processors 1232 can be configured to be coupled for communication over networks 1239a, 1239b through the internet 1239b. In some embodiments, one or more wired or wirelessly coupled components of the network 1239a, 1239b can include one or more resources for data storage. For example, in some embodiments, this can include any other form of computer readable media in addition to the computer readable media 1236 for storing information, and can include any form of computer readable media for communicating information from one electronic device to another electronic device.

Any of the operations described herein that form part of the invention are useful machine operations. The invention also relates to a device or an apparatus for performing these operations. The apparatus can be specially constructed for the required purpose, such as a special purpose computer. When defined as a special purpose computer, the computer can also perform other processing, program execution or routines that are not part of the special purpose, while still being capable of operating for the special purpose. Alternatively, the operations can be processed by a general-purpose computer selectively activated or configured by one or more computer programs stored in the computer memory, cache, or obtained over a network. When data is obtained over a network the data can be processed by other computers on the network, e.g. a cloud of computing resources.

The embodiments of the invention can also be defined as a machine that transforms data from one state to another state. The data can represent an article, that can be represented as an electronic signal and electronically manipulate data. The transformed data can, in some cases, be visually depicted on a display, representing the physical object that results from the transformation of data. The transformed data can be saved to storage generally, or in particular formats that enable the construction or depiction of a physical and tangible object. In some embodiments, the manipulation can be performed by a processor. In such an example, the processor thus transforms the data from one thing to another. Still further, some embodiments include methods can be processed by one or more machines or processors that can be connected over a network. Each machine can transform data from one state or thing to another, and can also process data, save data to storage, transmit data over a network, display the result, or communicate the result to another machine. Computer-readable storage media, as used herein, refers to physical or tangible storage (as opposed to signals) and includes without limitation volatile and non-volatile, removable and non-removable storage media implemented in any method or technology for the tangible storage of information such as computer-readable instructions, data structures, program modules or other data.

The previous description of the disclosed examples is provided to enable any person of ordinary skill in the art to make or use the disclosed methods and apparatus. Accordingly, the terminology employed throughout should be read in a non-limiting manner. Various modifications to these examples will be readily apparent to those skilled in the art, and the principles defined herein may be applied to other examples without departing from the spirit or scope of the disclosed method and apparatus. The described embodiments are to be considered in all respects only as illustrative and not restrictive and the scope of the invention is, therefore, indicated by the appended claims rather than by the foregoing description. All changes which come within the meaning and range of equivalency of the claims are to be embraced within their scope. Skilled artisans may implement the described functionality in varying ways for each particular application, but such implementation decisions should not be interpreted as causing a departure from the scope of the disclosed apparatus and/or methods.

1. A computer-implemented method comprising:
providing an Internet enabled or coupled web server;
providing an Internet enabled or coupled domain authority server;
providing an Internet enabled or coupled application server, the application server configured and arranged to be coupled to a centralized database and at least one respondent display, and at least one of the web server and the domain authority server;
providing a non-transitory computer-readable medium coupled to at least one computing device and having instructions stored thereon which, when executed by the at least one computing device, cause the at least one computing device to perform one or more operations of managing software application versions, comprising:
determining application features in a version of a software application;
determining front-end components for the software application;
determining subscription requirements for subscribing to an upgraded version of the software application;
installing the upgraded version of the software application; and
providing a user with access and use-rights to the software application by automatically validating the upgraded version of the software application.

2. The method of claim 1, wherein the automatic validating includes a validation of meeting specific requirements of one or more specific regulations.

3. The method of claim 2, wherein the specific regulations are based on a validated clinical trial configuration.

4. The method of claim 2, wherein the specific regulations are based on a regulation of Title 21 CFR Part 11.

5. The method of claim 1, wherein the upgraded version is a later or newer version of the software application version.

6. The method of claim 1, wherein the application server configures a user display of one or more listings of multiple software application versions.

7. The method of claim 3, wherein at least one of the application server and the domain server enables a user to subscribe to multiple versions of the software application version.

8. The method of claim 4, wherein at least one of the application server and the domain server enables a user to update at least one software application version.

9. The method of claim 1, wherein installing the upgraded version of the software application comprises replacing one or more corresponding software components of a previously installed software application.

10. The method of claim 1, further comprising: comparing application features of a software application version with an upgraded software application version to determine software components required by the upgraded software application version.

11. The method of claim 7, wherein the upgraded software application version upgrade incorporates at least one incremental software component package.

12. The method of claim 7, wherein the upgraded software application version upgrade is automatically validated against predetermined criteria for regulatory compliance and integrity.

13. The method of claim 1, wherein the software application is a user-subscribed software application.

14. A system comprising:
an Internet enabled or coupled web server;
a software version management module;
a database in communication with the software version management module;
an application version change module in communication with the software version management module and a database;
an application validation module in communication with the software version management module and the database;
a non-transitory computer-readable medium coupled to at least one computing device and having instructions stored thereon which, when executed by the at least one computing device, cause the at least one computing device to perform operations of a software version management system, comprising:
determining application features in a version of a software application;
determining front-end components for the software application;
determining subscription requirements for subscribing to an upgraded version of the software application;
installing the upgraded version of the software application; and
providing a user with access and use-rights to the software application by automatically validating the upgraded version of the software application.

15. The system of claim 13, where the software application originates from or is authorized by at least one of an Internet enabled or coupled domain authority server and an Internet enabled or coupled application server coupled to the database.

16. The system of claim 13, wherein the database is configured to provide multiple software version components for a software upgrade in response to a query from the software version management module.

17. The system of claim 13, wherein the automatic validating includes a validation of meeting specific requirements of one or more specific regulations of Title 21 CFR Part 11.

18. The system of claim 13, wherein the operations of a software version management system comprise configuring a user display of one or more listings of multiple software application versions.

19. The system of claim 13, wherein the upgraded software application version upgrade is automatically validated against predetermined criteria for regulatory compliance and integrity.

20. The system of claim 13, wherein the software application is a user-subscribed software application.
